(19) United States
(12) Patent Application Publication
(10) Pub. No.: US 2005/0278652 A1
(43) Pub. Date: Dec. 15, 2005

(54) User interface controls

(76) Inventor: Martin Scholz, Nussloch (DE)

Correspondence Address: FISH & RICHARDSON, P.C., PO BOX 1022, MINNEAPOLIS, MN, 55440-1022, US

(21) Appl. No.: 10/865,022

(22) Filed: Jun. 10, 2004

(51) Int. Cl. G06F 3/00

(52) U.S. Cl. 715/780; 715/808; 715/809; 715/841; 715/842; 715/843

(57) ABSTRACT

Selection of a user interface control (UIC) type for display may be made by a user at run-time. Methods and computer program products described herein relate to selecting from among a plurality of UIC types at run-time instead of determining the UIC type at design-time. As such, an optimal UIC type may be selected according to run-time circumstances.

### BACKGROUND

When displayed on a computer display device, a user interface control (UIC) provides a convenient method for entering information into a computing system. Various types of UICs can each provide a convenient graphical user interface (GUI) through which information can be rapidly reviewed and selected. Generally, a mouse pointing device is used to select a desired value in UICs, although other mechanisms, such as keyboard command entry, can also be used. UICs may be used in combination with various application programs, such as, for example, a web browser, or other GUI.

In some computer-implemented business applications, the type of UIC that is used can dramatically impact productivity. For example, in a contact center application, an agent may respond to thousands of incoming messages each week. If the agent enters data about each contact using UICs, the time spent on each use of a UIC can affect the agent's productivity. Even saving several seconds each time the agent enters data using a UIC can significantly improve the agent's productivity.

What most computer-implemented business applications have in common is a more or less complex user interface into which the user enters some data. For some fields of the user interface, the entered data may be arbitrary text that is not checked for validity. For example, the first and last name of a new employee must be entered into a text input field, but these values are normally not subject to validity checks. However, data entered into other fields may have to be checked for validity by the computing system. For example, only “male” and “female” are valid values for the field “gender.” For another example, only those personnel areas that actually exist within the company are valid values for the field “personnel area.” For data entry fields that require validity checks, UICs of various types can be useful.

UICs for data entry can take various forms. Two exemplary types of UICs include a dropdown list box (DDLB), and an input field with associated pop-up window (IFWAPW). DDLBs may be a suitable type of UIC for displaying a list of all valid values. DDLBs require the user to select a value out of a list. Moreover, DDLBs prevent erroneous data entry because the user can only select from a predefined list of values.

However, DDLBs do not permit the user to directly type in the desired value. If the user already knows the desired value, then it may be more efficient to directly type in the value than to pick a value out of a list. Unlike a DDLB, an IFWAPW allows the user to directly type a value code into an input field. The user may type, for example, an alphanumeric value code (e.g., “221227,” or “ABC012”) into the input field. The value code typed into the input field may be associated with a valid value that the user intends to select. For example, in an application program that tracks employee records, the value codes “01” through “50” may each represent a different employee numbers. Because DDLBs do not allow the user to type in value codes, DDLBs are not generally suitable for users who are already familiar with these predetermined value codes. Where the user is already familiar with the codes values for frequently selected values, the IFWAPW may be more suitable than the DDLB, especially where the input field is associated with a very long list of values.

To select a value from an IFWAPW, the user can either enter the value code manually, or invoke a pop-up window that shows the complete list of possible values. The IFWAPW might also offer some sorting and searching capabilities that allow the user to quickly find and select the values of interest. However, these additional capabilities render the IFWAPW more complex than the DDLB, and thus less suitable for certain occasional users to whom relevant value codes are not familiar.

When incorporating a UIC into application software, developers and user interface designers decide which type of UIC to display for each input field. However, interface designers generally do not know at design-time how many values will be associated with each input field, or whether the run-time user will already be familiar with the relevant value codes. As such, the developer generally cannot predict which type of UIC would best serve the future run-time end user. Although guidelines may provide some uniform approach at design-time, guidelines generally do not accurately determine which UIC type would be most efficient for the end-users.

### SUMMARY

Selection of a user interface control (UIC) type for display may be made at run-time. Methods and computer program products described herein relate to performing the selection of a UIC type at run-time instead of determining the UIC type at design-time. The run-time decision may be made by a run-time user to override default selections. As such, an optimal UIC type may be selected according to run-time circumstances.

In one aspect, a method is used to select a user interface control (UIC) for receiving input into a computer system. The UIC is to be displayed on a display device. The method includes several steps. One of the steps is receiving a set of values that may be validly input into the computer system using the UIC. Another step is receiving a first set of instructions that, when executed, sends the UIC in the form of a drop-down list box to be displayed on the display device. Another step is receiving a second set of instructions that, when executed, sends the UIC in the form of an input field with an associated pop-up window (IFWAPW) to be displayed on the display device. The IFWAPW includes an input field into which a predetermined value code may be entered. The predetermined value code is associated with one of the values in the received set of values. The IFWAPW also includes a first user-selectable button associated with the input field. Selecting the first button causes a first window that displays information related to the received set of values to be displayed on the display device. Another step is receiving user input to select between executing the first set of instructions and executing the second set of instructions.

In another aspect, the steps of the foregoing method are carried out by a computer program product that contains executable instructions. When executed, the instructions cause a processor to perform operations to select a user interface control (UIC) for receiving input into a computer system. The UIC is to be displayed on a display device.

The above-describe method and computer program product aspects may include various features and modifications. For example, the user input to select between executing the first set of instructions and executing the second set of instructions may be received while executing an application program, or it may include selecting a second button that is displayed on the display device. In the latter case, the selected second button may be one of a number of UIC selector buttons that, when selected, cause a selection to be made between executing the first set of instructions and executing the second set of instructions. The number of UIC selector buttons may be displayed when the first window is displayed on the display device.

In some examples, the executable instructions of the application program include a default selection between executing the first set of instructions and executing the second set of instructions. This default selection may be overridden by the received user input.

In another aspect, a computer program product contains executable instructions that, when executed, cause a processor to perform operations to configure a user interface. One of the operations is to receive a number of values in a computer system. The computer system has a set of user input controls (UICs). Each UIC is capable of displaying values in the number of received values in the user interface such that any of the values may be selected to make an input into the computer system. Another of the operations is to select a UIC from among the set of UICs, wherein the UIC selection is determined from received user input. Another operation is to send the selected UIC to be displayed in the user interface.

The foregoing computer program product aspect may have various features and modifications. For example, the selected UIC may be selected from among the group consisting of: an input field with an associated pop-up window (IFWAPW), a dropdown list box (DDLB), a fixed list box, and a radio button list.

The foregoing aspects and modifications may provide certain features and advantages. For example, selecting a UIC at run-time alleviates the design-time problem that the application developers generally cannot accurately predict run-time circumstances. As such, the optimal type of UIC to select may not be known before run-time. As for example, some users prefer the efficiency of an IFWAPW, whereas other users may require the additional context information of a DDLB. Moreover, some sets of values are small enough so that it is practical to display them using a radio button list. On the other hand, some sets of values are impractical to display all at once. Accordingly, optimal selection of UIC type can promote efficiency and effectiveness for the end user of an application program.

The details of one or more examples are set forth in the accompanying drawings and the description below. Other features, objects, and advantages will be apparent from the description and drawings, and from the claims.

### DESCRIPTION OF DRAWINGS

FIG. 1 is a block diagram of a computer system for configuring a user interface at run-time by selecting one of the UICs of FIGS. 2A-2E.

FIG. 2A is a run-time UIC in the form of a radio button list control.

FIG. 2B is a run-time UIC in the form of a fixed list box control.

FIG. 2C is a run-time UIC in the form of a drop down list box.

FIG. 2D is a run-time UIC in the form of an input field including an icon for triggering an associated pop-up window.

FIG. 2E is a run-time UIC in the form of an input field with an associated pop-up window.

FIG. 3 is a run-time flow chart for selecting which of the UICs of FIGS. 2A-2E will be displayed.

FIG. 4 is a run-time UIC of FIG. 2E, with a user mode preference override feature in accord with the flow chart of FIG. 3.

Like reference symbols in the various drawings indicate like elements.

### DETAILED DESCRIPTION

This document describes a design-time code construct that, when executed at run-time, determines which of a plurality of UICs to display. The run-time decision as to which of the UICs to display is made upon a user selection. For another example, if the user is already familiar with the relevant value codes, the user might prefer to use an IFWAPW-type UIC. However, if the user is not already familiar with the relevant value codes, then the user might prefer to display a DDLB-type UIC.

For ease of understanding, the design-time code construct, or software, mentioned above will first be introduced in the context of a computing environment in which it may be designed and executed. Next, various exemplary run-time UICs that may be selected by this software will be described. Then, an exemplary flow chart illustrates the method steps that can be performed to allow the user to select a UIC at run-time. Finally, user-selection features are described.

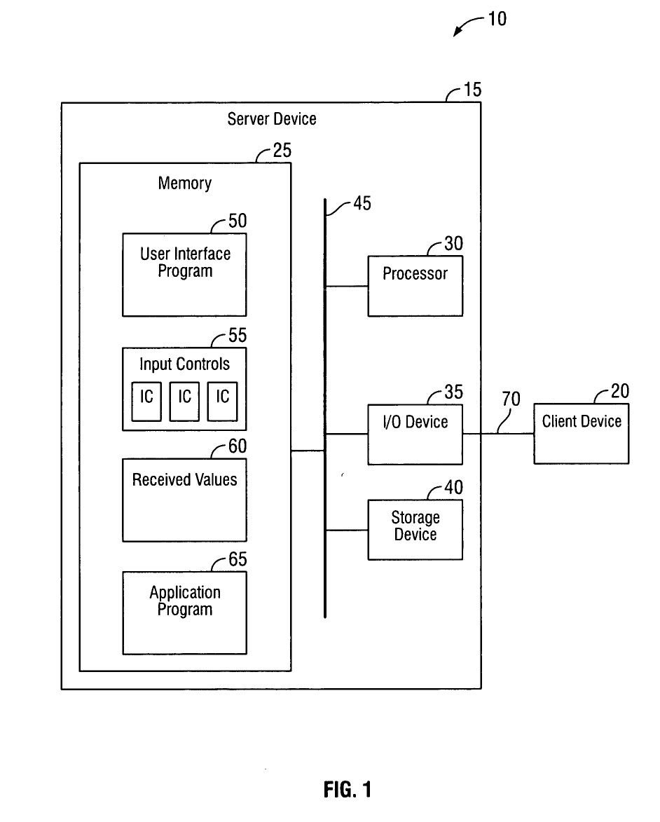

Turning first to the computing environment in which UICs may be selected for display, FIG. 1 shows a computer system 10 that includes a server device 15 connected to a client device 20. The server device 15 includes a memory 25, a processor 30, an input/output (I/O) device 35, and a storage device 40, all of which are connected by bus 45. The memory 25 of the server device 15 further includes a user interface program 50, a number of input controls 55, a number of stored received values 60, and an application program 65. In cooperation with these elements, the computer system 10 operates by the server device 15 communicating with the client device 20 over connection 70. The client device 20 may be a terminal for displaying information provided by the server device 15 and for receiving user input that can be processed and stored in the server device 15. Accordingly, the flow of information on communication link 70 is bi-directional.

In the server device 15, the above-described elements constitute a general computer system. The processor 30 controls the execution of programs and communicates with the other elements of the server device over the bus 45 to control, execute and store information flows within the computer system 10. The server device 15 also communicates with the client device 20. The I/O device 35 provides an interface between the bus 45 and the client device 20. As such, the I/O device 35 may include elements such as buffers and interrupt handling mechanisms. The storage device 40 provides for long-term storage of data that can later be recalled and placed into the memory 25 for use by the processor 30. For example, an application program may be stored on the storage device 40 and then loaded into the memory 25 under the control of the processor 30 and over the bus 45. After the application program has been loaded into the memory 25, the processor may display, for example, selected UICs on the client device 20.

Information can be stored in the memory 25 of the server device 15. Memory 25 typically represents random access memory (RAM) that the processor 30 can read and write over the bus 45 at high data rates. Stored at locations in the memory 25 is the user interface program 50 which represents executable instructions that may be executed by the processor 30 to determine at run-time which of the plurality of UICs 55 to display on the client device 20. In one example, this run-time determination may be based on the run-time user's preference. Generally, the user interface program 50 is executed in the process of executing the application program 65.

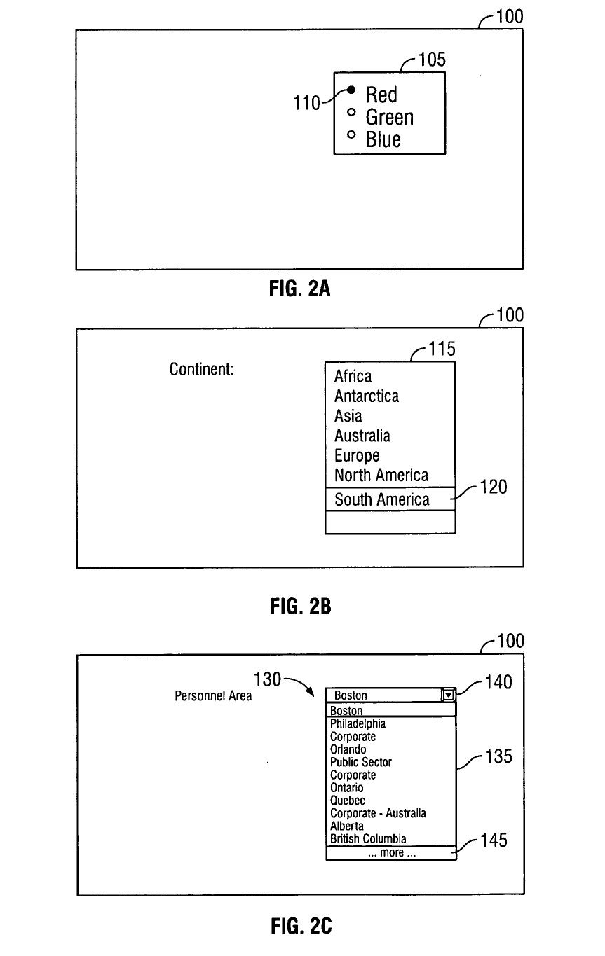

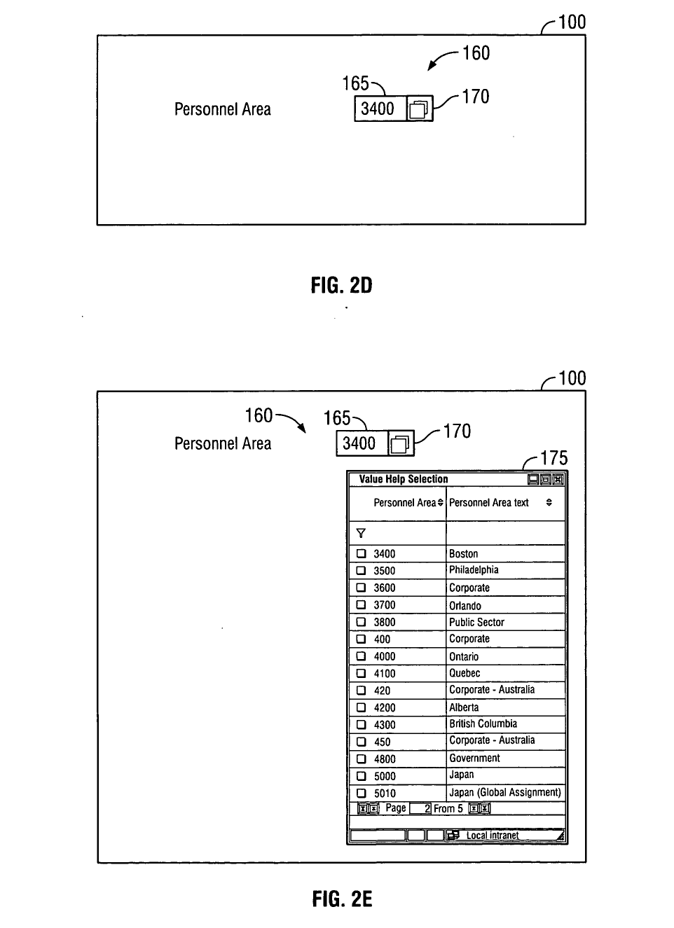

The UICs 55 that may be stored in the memory 25 of FIG. 1 can take various forms. FIG. 2A shows a display screen 100 that may be displayed on the client device 20 during the execution of an application program 65. One of the input controls 55 is displayed in the display 100 in the form of radio button list 105. The radio button list, in this example, has three values, each value having associated with it, and displayed adjacent to it, a selectable radio button. The first value, “Red,” has associated with it a selected button 110. The selected button 110 represents either a user-selected input of that value red, or a default selection. In some examples, a UIC may be displayed initially with a default selection. In other examples, no value is initially selected so that a user must select the appropriate selectable input field to enter or to input a selected value.

The radio list button control of FIG. 2A includes three values. If there were many more values to be displayed in the radio button list control 105, then a practical consequence would be that the displayed values would extend beyond the borders of the display 100. This limitation renders the radio button list control type of UIC practical for displaying only a limited number of values.

An alternative type of UIC, namely a fixed list box, is shown in FIG. 2B. The fixed list box 115 differs from the radio button list control 105 in that the selection is represented on the display as a highlighted value 120 in the fixed list box 115. Like the radio button list control 105, the fixed list box has a practical limitation as to the number of values that can be displayed on the display 100.

A more flexible type of UIC is shown in FIG. 2C. In the display 100, a drop down list box (DDLB) 130 is displayed in the display 100. Similar to the radio button list control 105 and the fixed list box 115, the drop down list box 130 includes a display of a limited number of values 135 when the DDLB drop down button 140 is selected. However, the DDLB 130 provides additional functionality. For example, the DDLB 130 includes an extendable display that may be accessed by selecting the “more” link 145. Selecting a more link 145 can cause a longer, larger, or more comprehensive list to be displayed. In some examples, selecting the more link 145 may activate features such as, for example, scroll bars for scrolling through a relatively long list. Accordingly, some embodiments of the DDLB type of UIC are useful for displaying a larger number of values than either the radio button list control 105 or the fixed list box 115 types of UICs.

An example application for which either a radio button list, fixed list box, or DDLB may be suitable is an input field for entering a student's grade. If, for example, the grade has to be entered in the system, possible values might be any grade from the list of (A+, A, A−, B+, B, B−, C+, C, C−). A user could enter such data, for example, by typing it into a simple input field, or by using one of the other above-mentioned UIC types.

Yet another type of UIC may be referred to as an input field with an associated pop-up window (IFWAPW). In some commercially available software, such as that offered by SAP, IFWAPWs are sometimes referred to as “value help” features, and may be activated in some cases using, for example, the “F4” function key. FIG. 2D shows a display 100 that includes an IFWAPW 160. The IFWAPW 160 includes an input field 165 and an associated pop-up window button 170. The input field 165 provides an area for the user to type in alphanumeric characters (e.g., “3400,” or “ABC019”) that represent a predetermined value code. In turn, each predetermined value code corresponds to a desired value that may be displayed or selected by the user. If the user knows the predetermined value code for each value the user wishes to select, then the IFWAPW-type UIC can save the user time because the user does not to have to select from a list of values by searching through a DDLB, such as that shown in FIG. 2C. However, if the user does not know a particular value code, the IFWAPW 160 allows the user to display of a list of valid values by selecting the associated pop-up window selection button 170.

When the associated pop-up window button 170 of the IFWAPW 160 is selected, a value help selection window 175 is displayed. The value help selection window 175 is configured to display a large number of values that may be selected for using this UIC. The value help selection window 175 can include, for example, scrolling features and advanced search capabilities that may be used to search for a desired value. In addition, the columns displayed in the value help selection window 175 may be sorted using various sorting techniques that are not the focus of this document.

In this example, the input field 165 is designed to receive a personnel area value code. The personnel area is coded in a 4-digit value with an associated text. These values and texts must be customized for each enterprise. This means the enterprise has to define all possible value/text pairs prior to using the software. This generally requires the enterprise to input data containing all possible values with their associated texts.

In this example, one UIC for displaying the personnel area input field is a simple text input field. In that case, the user has to enter the 4-digit value code without the benefit of any suggested valid values. As such, this is not very user-friendly solution for users who are unfamiliar with the value codes.

Users who need additional value code information can click the value help icon 170. The value help pop-up shows a list of all available personnel areas presenting the key as well as the associated text. This value help selection window 175 may offer sorting functionality (e.g., by the user clicking on the header line of a column) and searching functionality (e.g., by the user entering search criteria in the first dedicated row of the list). This helps the user to find the desired entry. When the user selects an entry from the list, the pop-up closes, and the selected value is displayed in the input field. For usability reasons, the associated text could be printed adjacent to the input field as well. This kind of value help has the disadvantage that it is rather complex to handle, and the user is confronted with value codes.

A less complex alternative to the IFWAPW is a DDLB. To prevent the user from being confused when using DDLBs, descriptive associated texts are displayed instead of value codes. DDLBs prevent invalid data entry because they only present valid values in the list. However, if the user knows the value code for some reason, the user has no opportunity to manually enter it. DDLBs are also less advantageous if the number of valid values is very large. If the user has to scroll through a long list and does not find the desired entry, the user may feel lost. In this case, the IFWAPW is generally preferred because it offers better sorting and searching functionality.

In current development environments, software developers and user interface designer often face the choice between using a DDLB or an IFWAPW. In the personnel area example, it may be very difficult to reach an optimal decision. On the one hand, the number of personnel areas (which corresponds to the number of received values 60 in FIG. 1) varies from enterprise to enterprise. There might be only very few personnel areas for small companies, but there might be thousands of personnel areas for very large companies. On the other hand, the number of entries might depend as well on the user working with the software. A global HR administrator, for example, might be authorized to manage all personnel areas of the company, whereas a local HR administrator might be authorized to manage only a few personnel areas. Accordingly, the global administrator may prefer an IFWAPW, while the local administrator may prefer a DDLB.

In addition to the number of received values that are displayed, the optimal choice of UIC may also depend on the personal preference of the user. For present purposes, two different categories of users may be identified: power users and occasional users. Power users may intensely work with the software each day for several hours. Occasional users may use the software very rarely, perhaps once a week for only a short time. Power users need to have their work done very quickly. As such, they need a quick system response and fast data entry. Therefore, power users generally prefer to perform data entry with a keyboard rather than a mouse. Over time, they learn the value codes of those business objects they frequently deal with. As such, for performance reasons, they directly want to type in the value codes, rather than selecting the relevant entry from a list. In general, then, power users generally prefer working with FWAPW.

Occasional users have different needs than power users have. Occasional users do not memorize most of the value codes of the business objects because they work with the software too infrequently. Therefore, they generally don't want to be confronted with value codes at all. Instead, occasional users generally prefer working with descriptive texts. Furthermore, occasional users prefer working with the mouse as far as possible because it is easier to handle. Usability, not speed, is the main issue for them. As such, occasional users generally prefer working with DDLBs.

When a software product is developed, it is often unclear whether power users, occasional users, or both will work with it. Sometimes, a user starts as an occasional user, gets to know the software over time, and eventually becomes a power user. A user can also be a power user for certain parts of the application program, and an occasional user for other parts.

Because power users are very concerned with performance, another factor that determines which type of UIC would be optimal is system response time. When working in an environment with separate client and server (like a browser), DDLBs might suffer critical performance limitations. Because all possible values of all DDLBs displayed on a screen must be transported to the browser in advance, there is no additional round trip to the server when the user opens a DDLB to select a value. However, in slow network environments, transporting a large number of values in advance may significantly slow down the response time of the application. IFWAPWs may overcome these disadvantages. The values displayed in the IFWAPW are only transported to the client if explicitly requested by the user. The user may request values be displayed in an IFWAPW by, for example, pressing the button 170 (FIG. 2E).

Given the various needs of individual users in various applications, it is apparent that some of the UICs of FIGS. 2A-2E may be more appropriate than other types. For example, if a very small number of values need to be displayed, then the radio button list control 105 or the fixed list box 115 may be the most appropriate choices. On the other hand, if a large number of values need to be displayed, then the IFWAPW 160 may be most appropriate. Nevertheless, some users may prefer the DDLB 130 instead. When developing an application program that involves UICs to displaying values and to receive user input, an application developer may not know how many values will actually have to be displayed, or whether the run-time user will be familiar with the relevant value codes. As such, it can be very difficult for the developer to determine at design-time which type of UIC would be optimal for all users at run-time.

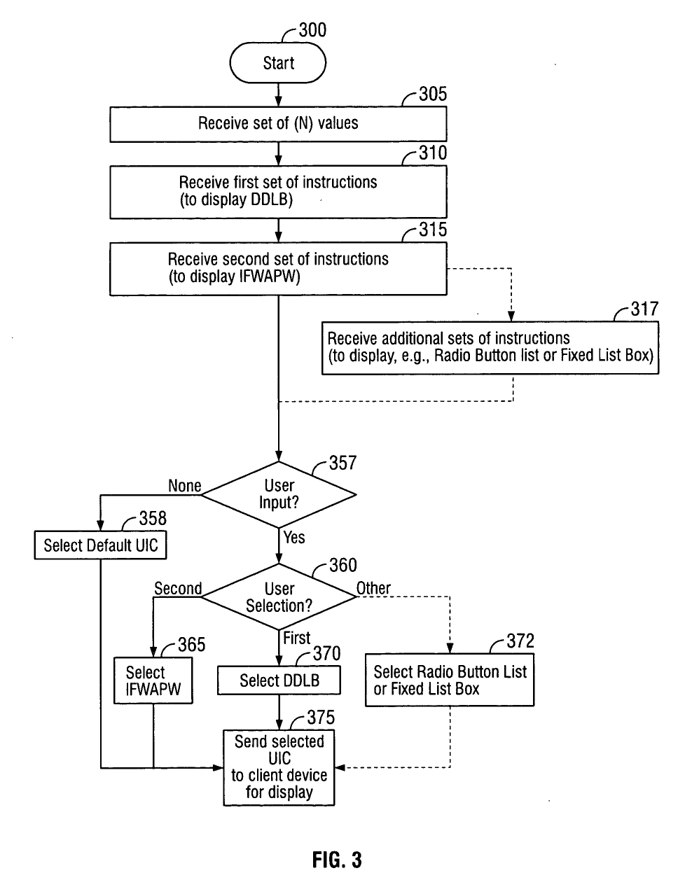

To address this design-time problem, the decision as to which type of UIC to use can be made at run-time. This run-time decision may be made manually by the user. One criterion the user may use may involve the user's preference. The steps by which a user may select the type of UIC to be displayed are presented in an exemplary flow chart in FIG. 3.

The steps of the method to be performed begin at step 300. The processor 30 receives a set of (N) displayable values at step 305. The server device 15 receives at step 310 a set of instructions that, when executed, causes a DDLB to be sent from the UIC 55 memory to be displayed. The server device 15 receives at step 315 a set of instructions that, when executed, causes an IFWAPW to be sent from the UIC 55 memory to be displayed. Optionally, the server device 15 may also receive at step 317 a set of instructions for each additional type of UIC that may be provided, such as for displaying a radio button list or a fixed list box.

A query for user input is made at step 357. If the user does not provide any input, then a default selection of UIC type is made at step 358. The default type may be pre-defined, for example, at design-time or at installation time. If the user does provide an input at step 357, then a user selection is determined at step 360. If the user selects the second set of instructions received at step 315, then the processor 30 will select an IFWAPW at step 365. If the user selects the first set of instructions received at step 310, then the processor 30 will select a DDLB at step 370. Optionally, if the user selects another set of instructions that may have been received at step 317, then the processor 30 will select a radio button list or a fixed list box, according to the instructions received at step 317. Then, at step 375, the server device 15 sends the user selected UIC to the client device 20 for display. The signals corresponding to this send command are transmitted from the I/O device 35, over the connection 70 to be received for display on the client device 20.

In various examples, the foregoing user selection may be stored in a configuration profile for that user, or in a configuration file that is applied to all future users of that client device. However, a future user could override such a previous user selection by performing the appropriate steps of the method of FIG. 3. The application program may also provide, for example, for being closed down and then restarted. In that case, the decision as to which type of UIC to select may again be made, for example, either according to the flow chart of FIG. 3 at run-time, or according to the most recent configuration file entry.

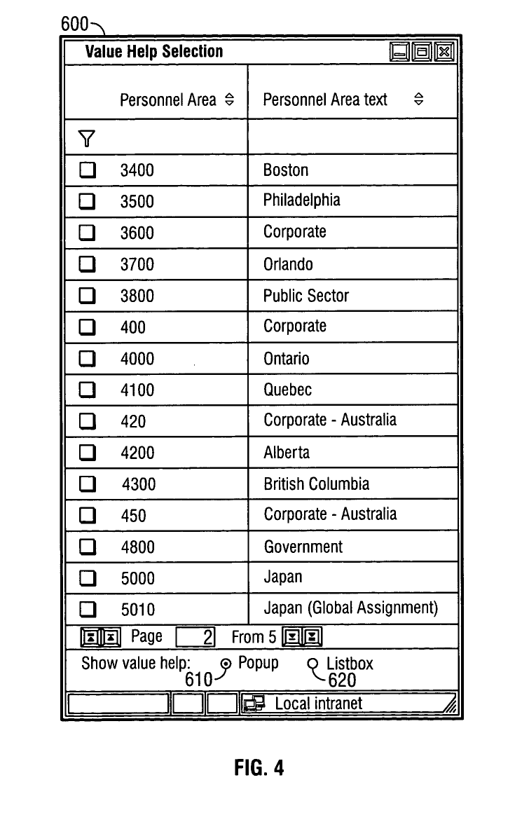

The user may make manual run-time decisions according to the flowchart in FIG. 3 by using an exemplary UIC 600 shown in FIG. 4. The UIC 600 is capable of being displayed either as an IFWAPW or as at least one other type of UIC. The UIC 600 includes user preference behavior controls by which the user can select between available UIC types. Specifically, the user can select a desired UIC type by selecting (in this example) either a radio button 610 or a radio button 620. If the run-time user selects button 610, then an IFWAPW type UIC will be used. On the other hand, if the user selects button 620, then a DDLB type UIC will be used.

With this manual selection functionality, it can be appreciated that the UIC 600 may initially be displayed in a default type that the developer may define at design-time. At run-time, the run-time user may override the default behavior by using, for example, buttons 610, 620. As such, the type of UIC that is displayed can be controlled flexibly by first the developer, and then by the run-time end user. Accordingly, the design-time decision as to which type of UIC to use need not be either entirely a developer decision or entirely a run-time user task.

The UIC 600 illustrates how the user can switch between IFWAPW and DDLB types of UIC from within a value help selection window 175 (FIG. 2E) augmented with buttons 610, 620. In some examples, the user can access the UIC 600 by selecting a pop-up window button icon, which may appear as the pop-up window button 170 (FIG. 2D) to change the selected UIC type. Accordingly, the user may select a pop-up window button associated with either the input field 165, as shown by IFWAPW 160 (FIG. 2D), or a DDLB. In the DDLB example, the UIC displayed to the user may include a DDLB 130, as shown in FIG. 2C, augmented with a pop-up window button. Although DDLB 130 is shown in FIG. 2C with the values 135 being displayed in response to drop down button 140 being selected, the pop-up window button associated with the DDLB may be displayed whether or not the list of values 135 is being displayed. By selecting the pop-up window button associated with either the DDLB or the IFWAPW, the user would be able to select from available UIC types using, for example, buttons 610, 620.

Although a user may be able to select the desired UIC type using the above-described buttons 610, 620, other examples are possible. For example, a dedicated key command, such as “F4,” may be configured to change the selected UIC type. Moreover, when the user selects a UIC type, the selection may be applied only to the UIC being accessed by the user, to all UICs currently being displayed, or to all UICs in an application. In some examples, the user selection may be maintained after the user “logs out” of the application and restarts the application. In a multi-user environment example, each user's UIC type selection may be associated with each user's account such that the computer system 10 responds according to each user's most recent UIC type selection.

A number of examples have been described. Nevertheless, it will be understood that various modifications may be made without departing from the spirit and scope of the invention. For example, if the overall list of possible values is very large, the use of DDLBs is normally not preferred. Nevertheless, in some examples, the DDLB might contain only some (most important entries) of the overall list of values along with a dedicated entry called ‘. . . more . . . ’ If the user picks the entry ‘. . . more . . . ,’ the value help pop-up may be invoked showing all possible values. Here the user might mark (select/deselect) those values the user wishes to see in the DDLB. This solution combines the benefits of both DDLB and value help pop-up. As an alternative to selecting the values by the user, there could be an algorithm that selects, for example, the 10 most recently used values.

In some implementations, the developer may define a default UIC selection that is initially displayed. For example, the developer could set the default for a particular input field to DDLB, or to IFWAPW. Instead of establishing a default, the application developer could specify that the initial display type is determined at the first run of the software at the end user. For example, if a customer uses the software with only 10 different personnel areas, the initial display type could be a DDLB type UIC. However, if the number of values exceeds a predetermined threshold (e.g., 15 entries), the initial display type could be set to select an IFWAPW type UIC.

In some examples, the software developer may make a default decision as to whether a DDLB or an IFWAPW should initially be displayed. However, in such examples, the user may be able to alter this default behavior at any time while working with the application.

This functionality may be part of a framework used for application development. This has the advantage that the application developer does not have to implement the functionality manually. It may be automatically available for all applications. The application developer only has to determine the initial (default) display type. This functionality may be implemented in cooperation with the setting of threshold conditions to select a UIC type.

There might be several different screens that contain the same field (e.g. personnel area). If the display type of the value help is changed for one of these fields, the new setting could be applied to all these fields (on all screens) immediately. This could either be the standard behavior, or there could be another option that allows the user to decide.

In various examples, the invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of the following claims.

1. A method of selecting a user interface control (UIC) for receiving input into a computer system, the UIC to be displayed on a display device, the method comprising:
receiving a set of values that may be validly input into the computer system using the UIC;
receiving a first set of instructions that, when executed, sends the UIC in the form of a drop-down list box to be displayed on the display device;
receiving a second set of instructions that, when executed, sends the UIC in the form of an input field with an associated pop-up window (IFWAPW) to be displayed on the display device, the IFWAPW comprising:
an input field into which a predetermined value code may be entered, the predetermined value code being associated with one of the values in the received set of values;
a first user-selectable button associated with the input field, wherein selecting the first button causes a first window that displays information related to the received set of values to be displayed on the display device; and
receiving user input to select between executing the first set of instructions and executing the second set of instructions.

2. The method of claim 1, wherein the user input to select between executing the first set of instructions and executing the second set of instructions is received while executing an application program.

3. The method of claim 2, wherein the received user input to select between executing the first set of instructions and executing the second set of instructions comprises selecting a second button that is displayed on the display device.

4. The method of claim 3, wherein the selected second button is one of a plurality of UIC selector buttons, and wherein each UIC selector button, when selected, causes a selection to be made between executing the first set of instructions and executing the second set of instructions.

5. The method of claim 4, wherein the plurality of UIC selector buttons is displayed when the first window is displayed on the display device.

6. The method of claim 2, wherein the application program includes a default selection between executing the first set of instructions and executing the second set of instructions.

7. The method of claim 6, wherein the default selection may be overridden by the received user input.

8. A computer program product containing executable instructions that, when executed, cause a processor to performs operations to select a user interface control (UIC) for receiving input into a computer system, the UIC to be displayed on a display device, the operations comprising:
receive a set of values that may be validly input into the computer system using the UIC;
receive a first set of instructions that, when executed, sends the UIC in the form of a drop-down list box to be displayed on the display device;
receive a second set of instructions that, when executed, sends the UIC in the form of an input field with an associated pop-up window (IFWAPW) to be displayed on the display device, the IFWAPW comprising:
an input field into which a predetermined value code may be entered, the predetermined value code being associated with one of the values in the received set of values;
a first user-selectable button associated with the input field, wherein selecting the first button causes a first window that displays information related to the received set of values to be displayed on the display device; and
receive user input to select between executing the first set of instructions and executing the second set of instructions.

9. The computer program product of claim 8, wherein the user input to select between executing the first set of instructions and executing the second set of instructions is received while executing an application program.

10. The computer program product of claim 9, wherein the received user input to select between executing the first set of instructions and executing the second set of instructions comprises selecting a second button that is displayed on the display device.

11. The computer program product of claim 10, wherein the selected second button is one of a plurality of UIC selector buttons, and wherein each UIC selector button, when selected, causes a selection to be made between executing the first set of instructions and executing the second set of instructions.

12. The computer program product of claim 11, wherein the plurality of UIC selector buttons are displayed when the first window is displayed on the display device.

13. The computer program product of claim 9, wherein the application program includes a default selection between executing the first set of instructions and executing the second set of instructions.

14. The computer program product of claim 13, wherein the default selection may be overridden by the received user input.

15. A computer program product containing executable instructions that, when executed, cause a processor to perform operations to configure a user interface, the operations comprising:
receive a plurality of values in a computer system, the computer system including a set of user input controls (UICs), wherein each UIC is capable of displaying values in the plurality of received values in the user interface such that any of the values may be selected to make an input into the computer system;
select a UIC from among the set of UICs, wherein the UIC selection is 9 determined from received user input; and
send the selected UIC to be displayed in the user interface.

16. The computer program product of claim 15, wherein the selected UIC is selected from among the group consisting of: an input field with an associated pop-up window (IFWAPW), a dropdown list box (DDLB), a fixed list box, and a radio button list.

17. The computer program product of claim 15, wherein the received user input is received while executing an application program.

18. The computer program product of claim 16, wherein the received user input comprises selecting a second button that is displayed on the display device.

19. The computer program product of claim 15, wherein the executable instructions include a default UIC selection.

20. The computer program product of claim 19, wherein the default selection may be overridden by the received user input.
